(19) United States
(12) Patent Application Publication
(10) Pub. No.: US 2020/0257735 A1
(43) Pub. Date: Aug. 13, 2020

(54) SYSTEM AND METHOD FOR PHRASE SEARCH WITHIN DOCUMENT SECTION

(71) Applicant: OPISOFT CARE LTD.

(72) Inventors: Alon ALTER, Raanana (IL); Oksana TOZHOVEZ, Petah-Tiqwa (IL); Erez PELEG, Hos-Hasharon (IL); Gideon ISRAELI, Tel-Aviv (IL)

(21) Appl. No.: 15/746,887

(22) PCT Filed: Jul. 26, 2016
(86) PCT No.: PCT/IL2016/050817

§ 371 Date: Jan. 23, 2018

(51) Int. Cl. G06F 16/93; G06F 16/958; G06F 16/9032; G06F 16/9038; G06K 9/62

(52) U.S. Cl. CPC G06F 16/93; G06F 16/986; G06K 9/6256; G06F 16/9038; G06F 16/90332

(57) ABSTRACT

A method and a system for searching phrases in document sections is presented. Systems that sift through documents, such as medical documents, need to extract information from specific section of a document. The method is comprised of three phases, which are training phase, document preparation phase and search phase. During training phase, the section headers of documents are defined. Once training is completed, each document is preprocessed to generate search indexes, which also identifies the section in which a word of the document appears. In the search phase the user specifies, both the search phrase and the sections where the phrase has to be found.

### CROSS REFERENCE TO RELATED APPLICATION

This application claims the benefit of U.S. Provisional Patent Application 62/197,438 filed on 27 Jul. 2015, which is incorporated herein by reference.

### TECHNICAL FIELD

The present invention generally relates to the field of document processing and in particular, to document section identification and search phrases within selected sections.

### BACKGROUND ART

Most search engines today do not bother themselves in separating documents into sections for their search (e.g. a website search). However, an efficient document search, opposed to an internet search, requires a search engine to look for particular phrases in a particular part of a document. Systems that sift through documents, such as medical documents, need to extract information from specific section of a document. For example, a specific phrase like “skin cancer” can have a different meaning if it is found in the testing section of a document or if it is in the summary section of a document.

The big problem with searching a document for a phrase located in a specific section is in teaching a computer driven system to determine the beginning and the end of a specific section.

US Publication number 2014/0068422 A1 describes a method of generating a document template that has paragraphs in it, and separating these paragraphs. It does not allow for the classification of different sections on existing documents.

US Publication Number 2012/0144292 A1 describes a method for summarizing digital documents. This system is able to determine individual paragraphs, but not sections in a document (which may contain several paragraphs).

US Patent Publication 2012/0254161 A1 describes a method of searching through documents and through different paragraphs of the document. However, this system searches for different terms in each paragraph and tries to associate different terms with paragraphs.

U.S. Pat. No. 7,813,808 discloses a method for categorizing document section heading, generating canonical section headers and transforming non-canonical section headers to canonical header. The method categorizes section headers only according to its contents but does not take into consideration layout characteristics.

U.S. Pat. No. 7,469,251 discloses a method for extracting sections of documents based on format features of the section and assign labels to those sections. The purpose is to enable ranking of documents in a search query.

Hence, there is a need for a system that can find phrases in specific sections of documents in general and in medical records in particular.

### SUMMARY OF INVENTION

### Technical Problem

In medical documents, the same phrases may appear in different sections. The meaning, from a medical point of view, differs significantly according to the section in which the phrase appears. For example, it is important to distinguish between “positive echocardiogram stress” appearing in “history” section and with the same phrase appearing in the “Diagnostics” section. In addition, section headers, may differ between medical documents in name, position, format, and fonts.

### Solution to Problem

The disclosed solution is to enable a user to post a query that specifies the section in which a phrase has to be found. The process is refer any sentence in a document to the section it appears in. It is comprised of a training phase, in which section headers are identified, content analysis in which each sentenced is chained to the document and to the section in which it appears and search phase, where the user can specify section from a list in which the phrase should be looked for.

### BRIEF DESCRIPTION OF DRAWINGS

FIG. 1 shows exemplary flowchart of the system training process.

FIG. 2 presents exemplary flowchart of the documents preparation process.

FIG. 3 illustrates exemplary flowchart of the search process.

### DETAILED DESCRIPTION

The invention will be described more fully hereinafter, with reference to the accompanying drawings, in which a preferred embodiment of the invention is shown. The invention may, however, be embodied in many different forms and should not be construed as limited to the embodiment set forth herein; rather this embodiment is provided so that the disclosure will be thorough and complete, and will fully convey the scope of the invention to those skilled in the art.

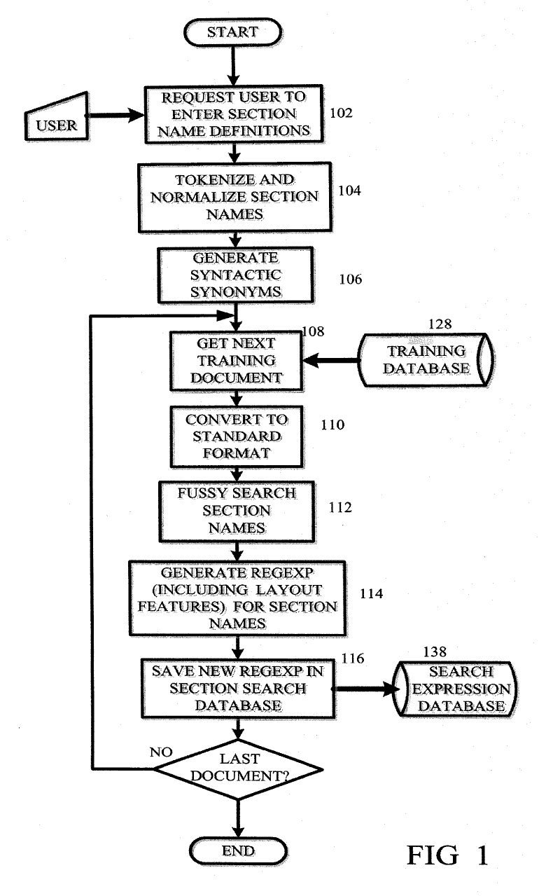

FIG. 1 describes the training process of the system's operation. The training is executed on samples of different types of documents generated in various organizations. In case of medical documents, they can be prepared in various clinics or hospitals, in different departments of hospitals etc. The documents are saved in training database. Each document includes metadata that keeps information on the source of the document (such as hospital, department, type and date).

The user or administrator, in step 102, enters textual definition of section headers. The user's definitions are tokenized and normalized in step 104 and syntactic synonyms are generated in step 106.

The loop containing steps 108 to 116 is repeated for each document in the training database 128. A single document is read in step 108. In addition, in step 110 the document is converted into standard format that contains the text and the formatting information. Fuzzy search is performed on the document in step 112. The fuzzy search is executed in order to find expressions similar to the ones defined by the user. For instance, the fuzzy search will find “summary and discussion” as well as “discussion and summary”, “in summary”, “conclusion and discussion” as equivalent section headers. The fuzzy search uses additional rules for finding section headers, such as that the header must be in a separate sentence, its font may be different from that of previous sentences etc. . . . . A set of regular expressions (REGEXP) that represents the characteristics of the found section headers is prepared in step 114, and are saved to search expression database 138 in step 116.

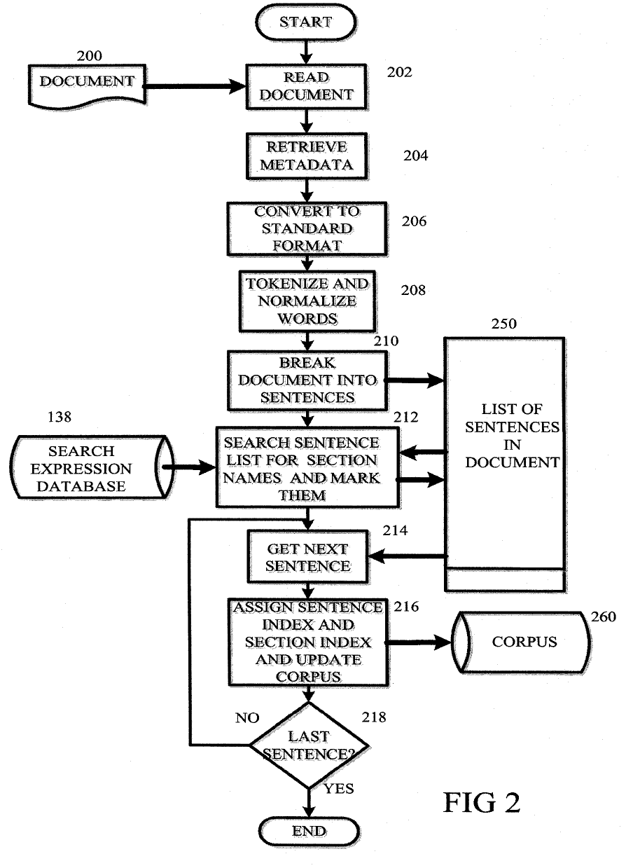

FIG. 2 describes the processing of each document that is entered in the system. The document 200 is read by the system in step 202, after which the metadata is extracted in step 204 to determine the format of the document. The format of the read document is converted into standard format in step 206, such as HTML, keeping all style information. The system then tokenizes and normalizes each word in the document—step 208, and then proceeds to break the document into sentences—step 210 which are temporarily stored in a list of sentences—250. Using the pre prepared search expression database 138, the system searches the entire document sentences saved in 250 is a section name—step 212, and marks those which are section headers. The list of sentences in document—250—contains all sentences of the document and the sentences which are section headers are marked. Note that a section header must be a sentence by itself. Then the system scans all sentences stored in the list of sentences in document 250, in a loop comprised of steps 214, 216. Each sentence is retrieved in step 214 and is assigned an index in the document and an index to the section in which it is included. The indexing information is saved in the corpus 260, which contains document database as well as all information required for execution of the search.

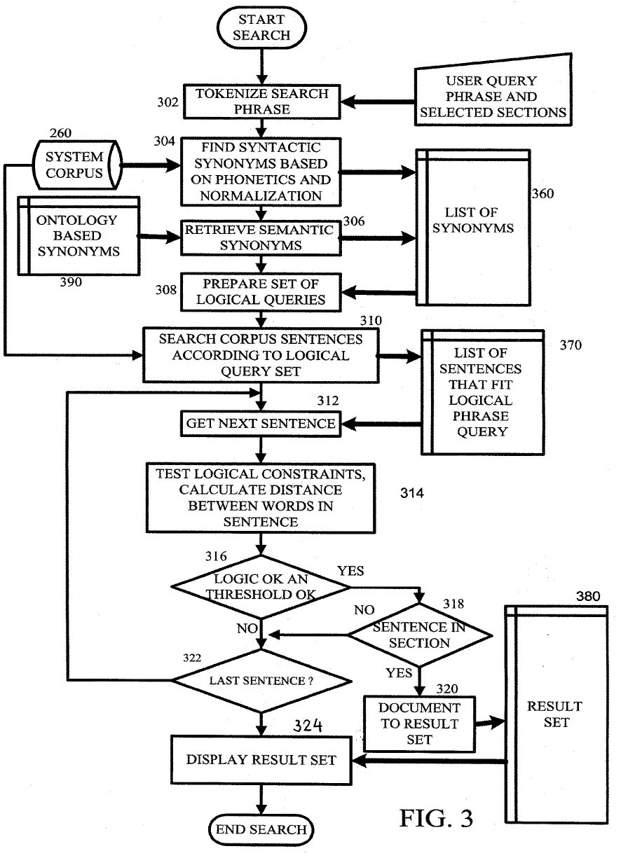

One implementation of a search process for finding query in a specific section of a medical document is shown in FIG. 3 . . . . For the purpose of explanation, we assume that there are three documents in the corpus that contain the following sentences respectively, “there is no sign of Carcinoma”, “Carzinoma has been ruled out”, and “no apparent sign of cancer”. These three sentences clearly express the same idea; however, one is in a section called “finding” and the other two in other sections. The user wants to find out the cases where cancer was suspected but was not found in “finding” section. The professional user enters the query phrase “no carcinoma” and select “finding” as the section name. The words of the query phrase all have to be in the same sentence, but they do not have to be consecutive. The expression “ruled out” is synonym for “no”, it may appear after the subject “carcinoma” in the sentence, and it gives the sentence the same meaning. Skin cancer, carcinoma, SCC are all semantic synonyms, and carcinoma is frequently misspelled as carzinoma, carsinome etc. The process as described hereafter can find all wording combinations that have the same meaning, and retrieve the document in which the required information is within the “finding” section.

The incoming search query is tokenized in step 302. For each word in the query, syntactic synonyms based on phonetic similarity and normalization are generated in step 304 and are temporarily saved in a List of Synonyms 360. The synonyms are looked for in the corpus 260. Referring to the above given example, in this step the words carcinoma, carzinoma, are found because they are similar from phonetic point of view. This similarity is determined by the distance between these words measured by Jaro-Winkler algorithm.

Semantic synonyms for each word in the query are derived in step 306 from an ontology 390, and are added to the List of Synonyms 360. Again, referring to the above given example, in this step the words cancer, SCC are semantic synonyms for carcinoma, and the words ruled-out, without, not and negative are semantic synonyms for “no”.

Using the stored list of synonyms 360, in step 308 a set of logical queries is prepared. The query set is comprised of all combinations of search phrases that express the same concept of the query. A search query within the set can include, in addition to the words, also logical constrains such as distance between the words in a sentence, or define that a specific word has to precede another one etc. For example, the query can include multiple phrases with logical operators that determine the relationship between them, e.g. hypertension OR [edema extremities]. Note that every query in the set includes the constraint that the words have to be in the same sentence. In step 310, the set of queries are applied to the documents in the system corpus 260, and a list of all sentences that contain the required words is prepared and these sentences are temporarily saved in a list 370.

A candidate search result sentence saved in the list 370 is popped from the list 370 in step 312. The logical constraints and the distance between words are evaluated in step 314. The maximum distance is checked against predefined threshold. If the logical constraints are met and the distance between the words in the sentence is below the query defined threshold, as tested in step 316, then, in step 318, the system checks if the sentence in which the search phrase was found is in the required section. If the answer is positive, the result set 380 is updated. If either steps 316 and 318 resulted negative answer, then a new sentence is fetched according to the decision in step 322 going back to step 312 if there are still sentences to be processed. After the last sentence was processed, the result set 380 is displayed to the user.

What has been described above is just one embodiment of the disclosed innovation. It is of course, not possible to describe every conceivable combination of components and/or methodologies, but one of ordinary skill in the art may recognize that many further combinations and permutations are possible. Accordingly, the innovation is intended to embrace all such alterations, modifications, and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

1. A computer-implemented method for searching phrases in document sections, the method comprising:
a. training process in which section header features are extracted from collection of training documents, the process is comprised of the following steps:
i. receiving textual section header names from user;
ii. generating syntactic synonyms for said section headers;
iii. converting each document in the training set to standard format keeping all formatting and graphical information;
iv. executing fuzzy search the document and extract section headers; and
v. saving header search expressions in search expression database;
b. preparation process executed on each new document entering the corpus, the preparation process is comprised of the following steps:
i. reading the document and convert it to standard format;
ii. tokenizing and normalizing the document;
iii. splitting document into sentences;
iv. marking sentences which are section headers; and
v. assigning sentence and section indexes; and
c. searching process which is comprised of the following steps:
i. receiving query from user including phrase and section header;
ii. retrieving documents which contains the requested phrase; and
iii. filtering out search results based on sections.

2. The computer-implemented method according to claim 1, where the user can define section headers by Regular Expression.

3. The computer-implemented method according to claim 1, where the standard format is HTML;

4. The computer-implemented method according to claim 1, where the extracted section headers are presented to the user for evaluation.

5. At least one computer readable storage medium encoded with instructions that, when encoded, perform a method for searching phrases in document sections, comprising acts of:
a. training process in which section header features are extracted from collection of training documents, the process is comprised of the following steps:
i. receiving textual section headers from user;
ii. generating syntactic synonyms for said section headers;
iii. converting each document in the training set to standard format keeping all formatting and graphical information;
iv. executing fuzzy search the document and extract section headers; and
v. saving header search expressions in search expression database;
b. preparation process executed on each new document entering the corpus, the preparation process is comprised of the following steps:
i. reading the document and convert it to standard format;
ii. tokenizing and normalizing the document;
iii. splitting document into sentences;
iv. marking sentences which are section headers; and
v. assigning sentence and section indexes; and
c. searching process which is comprised of the following steps:
i. receiving query from user including phrase and section header;
ii. retrieving documents which contains the requested phrase; and
iii. filtering out search results based on sections.

6. The at least one computer readable storage medium according to claim 5, where the user can define section headers by Regular Expression.

7. The at least one computer readable storage medium according to claim 5, where the standard format is HTML.

8. The at least one computer readable storage medium according to claim 5, where the extracted section headers are presented to the user for evaluation.

9. A system comprising: at least one processor programmed to:
a. execute training process in which section header features are extracted from collection of training documents, the process is comprised of the following steps:
i. receiving textual section headers from user;
ii. generating syntactic synonyms for said section headers;
iii. converting each document in the training set to standard format keeping all formatting and graphical information;
iv. executing fuzzy search the document and extract section headers; and
v. saving header search expressions in search expression database;
b. execute preparation process executed on each new document entering the corpus, the preparation process is comprised of the following steps:
i. reading the document and converting it to standard format;
ii. tokenizing and normalizing the document;
iii. splitting document into sentences;
iv. marking sentences which are section headers; and
v. assigning sentence and section indexes; and
c. perform searching process which is comprised of the following steps:
i. receiving query from user including phrase and section header;
ii. retrieving documents which contains the requested phrase; and
iii. filtering out search results based on sections.

10. The system according to claim 9, where the user can define section headers by Regular Expression.

11. The system according to claim 9, where the standard format is HTML.

12. The system according to claim 9, where the extracted section headers are presented to the user for evaluation.
